(19) United States
(12) Patent Application Publication
(10) Pub. No.: US 2025/0027676 A1
(43) Pub. Date: Jan. 23, 2025

(54) HEATING PLATE FOR A FLOW HEATER

(71) Applicant: BorgWarner Emissions Systems Spain S.L.U., Vigo (ES)

(72) Inventors: Julio Carrera, Vigo (ES); Miguel Folgar, Pontevedra (ES)

(21) Appl. No.: 18/768,709

(22) Filed: Jul. 10, 2024

(30) Foreign Application Priority Data
Jul. 17, 2023 (EP) 23 185 746.7

(51) Int. Cl. F24H 1/10; F28F 3/06

(52) U.S. Cl. CPC F24H 1/102; F28F 3/06; F24H 2250/02; F28F 2275/04

(57) ABSTRACT

Disclosed is a heating plate for a flow heater having a substrate made of metal, a heating resistor arranged on one side of the substrate and fins arranged on an opposite side of the substrate. The fins are brazed to the substrate, made of corrugated sheet metal and provided with a series of cuts across ridges of the corrugated sheet metal. According to this disclosure, the ridges are compressed such that opposing surfaces on the inside of the ridges contact each other.

### RELATED APPLICATIONS

This application claims priority to EP 23 185 746.7, filed Jul. 17, 2023, the entire disclosure of which is hereby incorporated herein by reference.

### BACKGROUND

This disclosure relates to a heating plate for a flow heater of the type generally known from, e.g., U.S. Publication No. 2022/0082297 A1.

The heating plate disclosed in U.S. Publication No. 2022/0082297 A1 has a substrate provided as a plate made of steel, and fins that are brazed to the substrate. The fins are made of corrugated sheet metal and provided with a series of cuts across ridges of the corrugated sheet metal. On one side of the substrate are the fins, and on an opposite side of the substrate are heating resistors provided as resistive tracks on a dielectric layer. Liquid to be heated flows both above furrows and below ridges of the corrugated sheet metal.

Such heating plates are used in flow heaters in vehicles for heating liquids. Constant objectives in the development of flow heaters for vehicles are a compact design, low manufacturing costs, and a high efficiency such that they can be operated at high power to heat a large amount of liquid in a short time.

### SUMMARY

This disclosure teaches a heating plate for a flow heater that is more efficient.

In a heating plate according to this disclosure, the ridges of the corrugated sheet metal of which the fins are made are compressed such that the fins are arranged at a distance that is larger than a thickness of the fins, said thickness measured at a position halfway between the proximal end of the fins and the distal end of the fins, e.g., at least 1.4 times as large.

By using compressed fins, the contact area between the corrugated sheet metal and the substrate is increased. The inventors have found that heat is more efficiently transferred away from the plate in areas of metal substrate that are contacted by the corrugated sheet metal than in areas that are directly in contact with liquid to be heated. The use of compressed fins therefore allows a much more efficient transfer of heat away from the substrate in comparison to heating plates as known from U.S. Publication No. 2022/0082297 A1.

In a refinement of this disclosure, opposing surfaces on the inside of the ridges contact each other between a bottom of the ridges connected to a substrate of the heating plate and a top of the ridges facing away from the substrate. In this way, the contact area between the corrugated sheet metal and the substrate can be increased even more.

Opposing surfaces on the inside of the ridges may touch each or by in contact via a connecting layer, e.g., a brazing layer.

In another refinement of this disclosure, narrow fins are created by compressing the ridges that may have a thickness that is three times as much as the thickness of the sheet metal they are made of or less, for example.

In a heating plate according to this disclosure, cuts across the ridges of the corrugated sheet metal greatly increases the flexibility of the fins. During the brazing process by which the fins are attached to the substrate, differences in thermal expansion of fins and metal substrate causes strains which might cause bending of the substrate. The cuts across the ridges make the fins more flexible and therefore reduce the risk of intolerable bending during brazing.

When the ridges of sheet metal are compressed to form the fins, cracks may form in the bend at a distal end of the fins, i.e., at the bend that joins both sides of a fin. Such cracks extend along the bend and are tolerable as they do not affect the function of the fins. Compressing the corrugations of sheet metal such that cracks form stabilizes the compressed fins.

In a refinement of this disclosure, the opposing surfaces on the inside of the ridges are connected by a substance-to-substance bond, e.g., brazing or welding. In this way the inside surfaces of the fins are fixed to each other. This facilitates handling of the fins and reduces strain on the substrate.

The thickness of the fins is about twice the thickness of the sheet metal the fins are made of. If there is a brazing layer inside the fins the thickness of the fins might be slightly larger than twice the thickness of the sheet metal the fins are made of, but even in this case the thickness of the fins is less than three times the thickness of the sheet metal the fins are made of.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a heating plate;

FIG. 2 shows the heating plate and fins brazed thereto; and

FIG. 3 a sectional view of the heating plate and fins.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

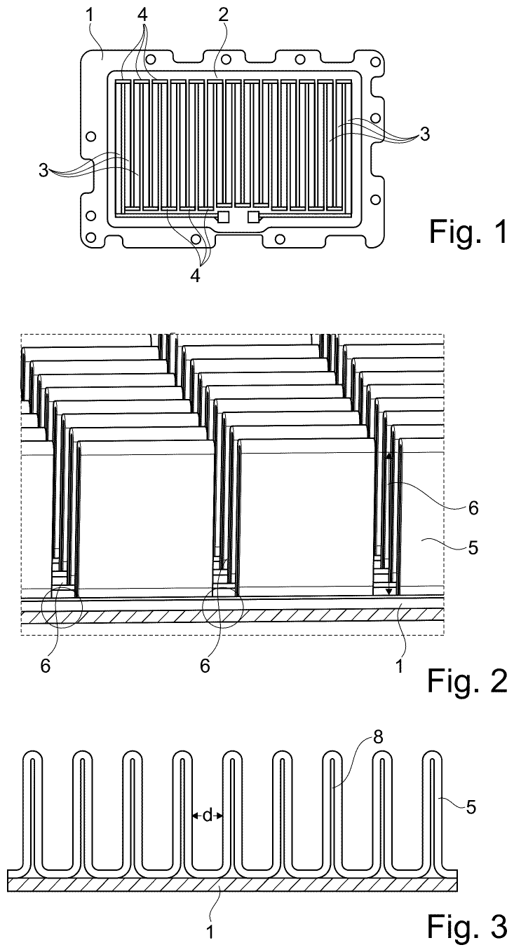

The heating plate shown in FIG. 1 comprises a substrate 1 made of metal, e.g., steel, an electrically insulating layer 2 covering the substrate 1, and a heating layer comprising resistive tracks 3 arranged on the insulating layer 2 and thereby electrically isolated from the substrate 1. The resistive tracks 3 are arranged side by side, e.g., as strips parallel to each other. The resistive tracks 3 may be electrically connected in series by connecting sections 4. The connecting sections are made of a metal that has a lower resistance than the resistive tracks 3. In operation, the resistive tracks 3 provide heat as heating resistors and only a negligible amount of heat is generated by the connecting sections 4.

FIG. 1 shows the dry surface of the heating plate. In operation, the dry surface is not in contact with liquid to be heated. The opposite surface of the heating plate is provided with fins 5 shown in FIGS. 2 and 3. The fins 5 are brazed to the substrate 1 of the heating plate and made of corrugated sheet metal, e.g., an aluminum-based alloy. The fins 5 are provided with a series of cuts 6 across ridges of the corrugated sheet metal. The cuts 6 improve the flexibility of the sheet metal and reduce thermal strains on the substrate 1 that may arise during brazing.

As can be seen in FIG. 3, the ridges of the sheet metal forming the fins 5 are compressed such that the fins 5 are arranged at a distance that is larger than a thickness of the fins 5, said thickness measured at a position halfway between the proximal end of the fins and the distal end of the fins.

In the embodiment shown, opposing surfaces on the inside of the ridges are in contact in an area between a bottom of the ridges adjacent to the substrate 1 and a top of the ridges facing away from the substrate 1. In the embodiment shown, opposing surfaces on the inside of the ridges are connected by a brazing layer 8, i.e., in contact via a brazing layer 8. Hence, the thickness of the fins 5 is twice the thickness of the sheet metal the fins 5 are made of plus the thickness of the brazing layer 8. Generally, the thickness of the fins 5 is less than 3 times the thickness of the sheet metal folded to form the fins 5. For example, the thickness of the sheet metal the fins 5 are made of may be in the range of 0.3mm to 0.6 mm and the thickness of the brazing layer 8 may be 0.2 mm to 0.4 mm.

If opposing surfaces on the inside of the ridges are not brazed to each other, i.e., in contact via a brazing layer, as shown in FIGS. 2 and 3, opposing surfaces on the inside of the ridges may simply touch each other.

As shown in FIG. 2, the cuts 6 may extend from the top or distal end of the fins 5 close to the substrate 1. Ideally, the cuts 6 end at a distance from the substrate 1 that corresponds to the thickness of the corrugate sheet metal, i.e., half the thickness of the fins 6. However, good results may already be achieved if the cuts 6 end at a distance from the substrate 1 that is not more than the thickness of the fins 5. The cuts 6 may have a width that is larger than half the thickness of the fins 5 and smaller than twice the thickness of the fins 5.

The fins 5 are arranged at a distance d of each other that is larger than the thickness of the fins 5, for example, at a distance d that is larger than 1.8 times the thickness of the fins 5, but smaller than five times the thickness d of the fins 5. The cuts 6 may have a width that is larger than the thickness of the fins 5 and smaller than lo times the thickness of the fins 5, for example.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 substrate
2 insulating layer
3 resistive tracks
4 connecting sections
5 fins
6 cuts
8 brazing layer
d distance between fins

What is claimed is:

1. A heating plate for a flow heater, comprising:
a substrate made of metal;
a heating resistor arranged on one side of the substrate and fins arranged on an opposite side of the substrate;
wherein the fins are brazed to the substrate, made of corrugated sheet metal and provided with a series of cuts across ridges of the corrugated sheet metal; and
wherein the ridges are compressed such that the fins are arranged at a distance that is larger than a thickness of the fins, said thickness measured at a position halfway between proximal and distal ends of the fins.

2. The heating plate according to claim 1, wherein opposing surfaces of the sheet metal on the inside of the fins contact each other.

3. The heating plate according to claim 1, wherein opposing surfaces of the sheet metal on the inside of the fins are connected by brazing.

4. The heating plate according to claim 1, wherein the heating resistor comprises a resistive track, and wherein a dielectric layer is arranged between the resistive track and the substrate.

5. The heating plate according to claim 1, wherein the substrate is made of steel.

6. The heating plate according to claim 1, wherein and the fins are made of an aluminum-based alloy.

7. The heating plate according to claim 1, wherein opposing surfaces on the inside of the ridges are in contact in an area between a bottom of the ridges connected to the substrate and a top of the ridges facing away from the substrate.

8. The heating plate according to claim 1, wherein the fins are arranged at a distance that is larger than 1.8 times the thickness of the fins and smaller than five times the thickness of the fins.

9. The heating plate according to claim 1, wherein the cuts have a width that is larger than half the thickness of the fins. 10 The heating plate according to claim 9, wherein the cuts have a width that is larger than the thickness of the fins and smaller than ten times the thickness of the fins.

11. The heating plate according to claim 1, wherein the thickness of the fins is less than three times the thickness of the sheet metal the fins are made of.

12. The heating plate according to claim 1, wherein cracks extend along a bend at a distal end of the fins.

13. The heating plate according to claim 1, wherein the fins are arranged at a distance that is at least 1.4 times as large as the thickness of the fins, said thickness measured at a position halfway between the proximal end of the fins and the distal end of the fins.

14. A heating plate for a flow heater, comprising:
a substrate made of metal;
a heating resistor arranged on one side of the substrate and fins arranged on an opposite side of the substrate;
wherein the fins are brazed to the substrate, made of corrugated sheet metal and provided with a series of cuts across ridges of the corrugated sheet metal;
wherein the ridges are compressed such that the fins are arranged at a distance that is larger than a thickness of the fins, said thickness measured at a position halfway between the proximal end of the fins and the distal end of the fins; and
wherein opposing surfaces of the sheet metal on the inside of the fins are brazed to each other.
